(19) United States
(12) Patent Application Publication
(10) Pub. No.: US 2019/0220928 A1
(43) Pub. Date: Jul. 18, 2019

(54) Superimposing an Options Risk Profile Over a Visual, Volatility-Rank-Per-Strike Options Chain to Maximize Volatility Reversion Potential Between Option Strikes

(71) Applicant: Morris Donald Scott Puma, San Francisco, CA (US)

(72) Inventor: Morris Donald Scott Puma, San Francisco, CA (US)

(21) Appl. No.: 16/246,561

(22) Filed: Jan. 14, 2019

Related U.S. Application Data
(63) Continuation-in-part of application No. 15/956,737, filed on Apr. 18, 2018.
Application No. 15/956,737 is a continuation-in-part of application No. 15/272,378, filed on Sep. 21, 2016.
Application No. 15/272,378 is a continuation of application No. 14/540,035, filed on Nov. 12, 2014, now abandoned.
Application No. 14/540,035 is a continuation-in-part of application No. 14/312,662, filed on Jun. 23, 2014, now abandoned.
Application No. 14/312,662 is a continuation-in-part of application No. 15/489,726, filed on Apr. 17, 2017.
Application No. 15/489,726 is a continuation-in-part of application No. 15/272,378, filed on Sep. 21, 2016.
Application No. 15/272,378 is a continuation of application No. 14/540,035, filed on Nov. 12, 2014, now abandoned.
(60) Provisional application No. 62/486,788, filed on Apr. 18, 2017.
(60) Provisional application No. 61/837,634, filed on Jun. 21, 2013.
(60) Provisional application No. 61/902,758, filed on Nov. 11, 2013.
(60) Provisional application No. 61/902,760, filed on Nov. 11, 2013.
(60) Provisional application No. 62/323,571, filed on Apr. 15, 2016.
(60) Provisional application No. 62/337,394, filed on May 17, 2016.
(60) Provisional application No. 62/337,407, filed on May 17, 2016.

(51) Int. Cl. G06Q 40/06; G06Q 40/04

(52) U.S. Cl. CPC G06Q 40/06; G06Q 40/04

(57) ABSTRACT

Methods and computer software for options trading, and more specifically, for analyzing a potential options trade instantaneously are described.

### CROSS-REFERENCE TO RELATED PATENT APPLICATIONS

This application claims priority under 35 USC 120 as a continuation-in-part application to U.S. patent application Ser. No. 15/956,737, filed Apr. 18, 2018, which claims priority under 35 USC 119(e) to U.S. Provisional Application No. 62/486,788, filed Apr. 18, 2017; this application also claims priority under 35 USC 120 as a continuation-in-part application to U.S. patent application Ser. No. 15/272,378, filed Sep. 21, 2016, which is a continuation of U.S. patent application Ser. No. 14/540,035, filed on Nov. 12, 2014, now abandoned, which is a continuation-in-part of U.S. application Ser. No. 14/312,662, filed on Jun. 23, 2014, now abandoned, which claims priority under 35 USC 119(e) to U.S. Provisional Application No. 61/837,634, filed Jun. 21, 2013; the '035 application also claims priority under 35 USC 119(e) to U.S. Provisional Application No. 61/902,758, filed on Nov. 11, 2013, and U.S. Provisional Application No. 61/902,760, filed on Nov. 11, 2013; this application further claims priority under 35 USC 120 as a continuation-in-part application of U.S. patent application Ser. No. 15/489,726, filed Apr. 17, 2017, which is a continuation-in-part of Ser. No. 15/272,378, filed Sep. 21, 2016, which is a continuation of the '035 application; and U.S. patent application Ser. No. 15/489,726, also claims priority under 35 USC 119(e) to U.S. Provisional Patent Application Nos. 62/323,571, filed Apr. 15, 2016, 62/337,394, filed May 17, 2016 and 62/337,407, filed May 17, 2016, the contents of each herein listed document being hereby incorporate by reference in their entirety.

### FIELD OF THE DISCLOSURE

The invention relates generally to computer hardware and distributed computer networks, and more specifically, to a remote options server to assist options traders to construct options spreads superimposed over a visual, volatility-rank-per-strike option chain or any other visual, option chain chart

### BACKGROUND OF THE DISCLOSURE

Options are complex and some of their attributes include option Greeks, volatility, option prices, days to expiration and the price of the underlying. Price changes of options are affected by many aspects such as moneyness, days to expiration, changes in time, volatility, underlying price moves, interest rates, liquidity and pending news, just to name a few. Since so many things affect an option's price, the exact future value of an option is unpredictable.

Since the exact future price of an option is difficult to forecast, methods are in demand to calculate future options pricing as accurately as possible. Additionally, methods are needed to forecast market behavior more accurately, and methods are also needed to help a trader know exactly which options strategy is the best one to use at any given moment. There are nearly an infinite number of options strategies a trader can construct and constructing the most optimized options strategy for consistent success is difficult.

Currently, the majority of options traders construct option trades based on days to expiration, liquidity, theta, gamma, delta and vega. However, the majority of traders do not optimize their trades for volatility reversion per strike because the required information for optimization is not available to them. Most traders, unknowingly, are consistently entering trades at the wrong time and with a poor structure for their existing environment.

A put back-ratio comprises 2 put options, a short and a long with more long contracts than shorts. A trade configuration could be BUY 2 puts at the −0.10 delta and SELL 1 put at the −0.20 delta. If a trader enters this trade with a negative volatility-ranked skew, meaning the long contract has a higher volatility rank than the short contract, then this trade will mostly likely be at a debit price. This is because the trader is “buying high and selling low”, which is detrimental to the trade. The traditional option chain does not display ranked-volatility per strike to the user, so the user does not understand this. In this situation the trader is at a loss from the get-go of the trade, and during the life of the trade, if the ranked-volatility skew reverses, and the rank of the short contract increases relative the long contract, a drawdown will most likely occur on the trade.

Options traders are making trading mistakes each day because current software does not provide traders with a method to compare option contracts to each other, and the result is traders buy and sell options at disadvantageous prices over and over.

### SUMMARY

To overcome the shortcomings of the prior art, computer-implemented methods, non-transitory computer readable media and an options server device provide models and comparisons of multiple, optimized trading opportunities for options visually superimposed in real-time.

More specifically, one embodiment comprises the following steps:

1. Ranking the implied volatility an option-able underlying asset with adjustable loopback periods of time.

2. Ranking each of the asset's options expiries to create three unique ranked term structure charts, one comprising puts, one comprising calls and another combining puts and calls.

3. Ranking the volatility of every individual option of the underlying asset by constant strike and/or constant delta with various loopback periods to create a database of millions of ranked volatility points per underlying asset.

4. Superimposing a risk profile of an options position over the visual, volatility-rank option chain.

5. Providing user a clean interface to analyze options spreads, manage them and create new ones as superimposed over the visual, volatility-rank option chain. The invention is also a new design of the option chain.

6. Providing user with a method to view many options spreads over the visual, volatility-rank option chain, quickly for comparison.

7. Providing user with a rank score of each option and/or option spread according to individual volatility ranks of each option, their skews and sums. An unranked method is also described this patent application for further protection of the invention herein.

8. Providing user with method to move each option's strike to maximize the volatility reversion potential of the options' relative positions to each other.

In one embodiment, market and attributes of a multitude of option trade models for a user (each option is also analyzed within each model) are analyzed and the most optimized options trade model with the current market environment and its forecasted changes are matched.

In another embodiment, the invention will analyze past and current trades, price-action and volatility ranks, in order to prepare future trade management rules once trades are initiated. Exits and adjustment rules can be created when reversion between strikes meets the expected move. This relates to Snapback invention. Implementation of AI saves an options trader great amounts of time and provides a user with information that could not be obtained otherwise. The algorithms behind building trades for the user are very complex and provide a user with instant, highly optimized trades.

Advantageously, options behavior is predicted through a comparison to other options and noting each option relative volatility position to each other. Now, the trader can design more effective options spreads with the predicted relationships between multiple options prices and knowing the exact future price of options is not so critical.

### BRIEF DESCRIPTION OF THE SEVERAL VIEWS OF THE DRAWINGS

In the following drawings, like reference numbers are used to refer to like elements. Although the following figures depict various examples of the invention, the invention is not limited to the examples depicted in the figures.

FIG. 1 is a high-level block diagrams illustrating a volatility-ranking per strike option chain system, according to an embodiment.

FIG. 2 is a high-level flow chart illustrating and a method for volatility-ranking per strike option chain system, according to an embodiment.

FIG. 3 is a block diagram illustrating an exemplary computing device 900 for use in the system 100 of FIG. 1A, according to one embodiment.

FIG. 12 depicts, “Tops”, a relative, ranked term-structure chart that displays top performing trades for a user over a selected period of time, according to an embodiment.

FIG. 13 depicts, “Position Block and Analyze & Order Block” for user to monitor trades and adjustments, according to an embodiment.

FIG. 14A depicts the “Options Month Cycles” drop down, which is color-coded to rank each month, according to an embodiment.

FIG. 14B depicts “Copy and Paste Trade” which allows user to copy any selected trades and instantly build a copy of said trade, according to an embodiment.

FIG. 15 depicts a global control for user to quickly sort by Puts, Puts and Calls or Calls only, according to an embodiment.

FIG. 16 depicts the multiple price range selector for the instant backtest and trading rule creator, according to an embodiment.

FIG. 17 depicts the “Create Preset Assistant,” which helps user to create large amounts of preset historical price changes of an underlying asset for instant backtesting, according to an embodiment.

FIG. 18 depicts “Preset Price Ranges” for instant backtesting purposes, according to an embodiment.

FIG. 19 depicts an example instant backtest, according to an embodiment.

FIG. 20 depicts and profit and loss chart of a backtest, according to an embodiment.

FIG. 21 depicts a menu for user to quickly navigate and view each back test performed.

FIG. 22 depicts instant trading rules, according to an embodiment.

FIG. 23 depicts another version of the visual, volatility-rank per strike option chain invention, according to an embodiment.

FIG. 24A depicts a control panel for FIG. 24B. The block shown comprises a user's options trade models.

FIG. 24B depicts another design of visual, volatility-rank per strike option chain, according to one embodiment.

FIG. 25 depicts previously submitted image of visual, volatility-rank per strike option chain.

FIG. 25B depicts previously submitted image from a ranked-per-strike and adjustable volatility smile chart.

FIG. 26 depicts “Stop & Gom” chart, which helps user to know when to enter and exit a trade based on the volatility relationships between strikes and other criteria.

FIG. 27 diagram charts a historical view of the sum of the IV of all contracts in rank or value form.

FIG. 28 This diagram charts the ranked volatility or unranked volatility of each option contract of the option spread.

FIG. 29 depicts a historical skew chart between option contracts, ranked or unranked, volatility or price.

### DETAILED DESCRIPTION

The following detailed description discloses computer-implemented methods, non-transitory computer readable media and an options server provide models and comparisons of multiple, optimized trading opportunities for options (e.g., in real-time).

Prior art of a volatility-rank-per-strike option chain interface plots the unranked implied volatility of each option of an underlying asset. One embodiment of the invention plots the implied volatility rank of each option of an underlying asset, which provides option traders with new, advantageous information. An embodiment ranks the relationships between every strike of the underlying asset using various formulas.

Prior art of the volatility-rank-per-strike option chain interface is not designed for options traders to execute trades from, and since it does not rank each volatility, option traders cannot execute trades from ranked volatility data. The invention herein provides various implementations of devices for options traders with a new interface to build and execute orders from volatility ranks per strike, which is a new design of the option chain, over a distributed computer network.

In another embodiment, a new design of the option chain, can plot tens of thousands of options onto one monitor screen while prior art of the option chain requires a user to scroll down dozens of times to see as many option contracts.

By creating a visual, volatility-rank per strike option chain a user is able to construct optimized options spreads to maximize the benefits of volatility reversion between option contracts.

By the invention's design a user can effortlessly and visually move option strikes vertically and horizontally, individually or as a group, to fit perfectly into the current ranked volatility levels of each strike. The design provides a user a clear method to maximize volatility reversion potential, very precisely.

By design, a user can clearly see and compare the volatility ranks of thousands of option contracts and their relationships.

By ranking each call and put separately, additional advantageous information is achievable such as ability to forecast direction of an underlying asset with great accuracy. Backtests demonstrated that some algorithms achieved over a 90% accuracy on predicting next-day underlying price action behavior.

By ranking each option individually, we also create multiple ranked term-structure charts, one for puts, one for calls and one combined. Prior art does not rank the term structure chart and does not separate puts from calls. The invention provides information to the user such as which months to buy and sell options and which direction the underlying asset should go in the future. Users can also see which price direction is predicted over time. For example, if the put rank is higher 200 days from expiration, then there may be a higher probability the underlying will move down within 200 days.

The invention herein can also be used for pairs trading. By ranking each option of each underlying asset, a user can create advantageous pairs of options using multiple underlying assets.

Another implementation also provides information related to entry and exit points of a spread. When the skew is the greatest between the volatility ranks of short and long contracts, then an entry signal is issued. When volatility reversion has been achieved between short and long option strikes, then an exit signal is issued. Therefore, the invention can help option traders improve their entry and exit timing to maximize profits of volatility expansion and reversion.

Since volatility expansion and reversion is also presented through the multiple ranked term-structure charts, profits are also maximized by options expiration cycles as well.

Preferred embodiments are not limited to plotting ranked volatility per each contract. Users are provided with a method to input any formula through all options for comparison. For example, a user could compare Theta/Gamma for all options, which would give an option trader insight related to daily theta income vs directional risk. A user could build trades around this information.

The techniques described herein provide a method to improve options trading through thorough comparative analysis of an underlying and all its options, expiration cycles, and calls and puts, of which the results of a user's formula are combined onto a chart along with a risk profile, superimposed.

In order to rank the volatility of each option and to calculate other formulas, various loopback periods of time are required since not all options have the same amount of historical data.

Various methods can be used to calculate ranks such as constant strike or constant delta.

The invention also uses variable loopback periods to rank the underlying asset itself.

The invention superimposes a risk profile over the visual, volatility-rank per strike option chain.

The invention uses drag and drop navigation on top of the visual, volatility-rank per strike option chain, to simplify managing trades and placing orders.

The design provides a user with a method to compare hundreds of trade designs over customized, formulated, visual, option chains (ranked volatility or another), ranking each trade model for quick sorting.

The invention also backtests each options trade for at least a day, so user has a perspective regarding the current price of the option or spread.

The invention is used for backtesting, to study real trades, and for building new trades.

The data created by the invention is also plotted historically. This allows users to see the historical trend of each calculation and by plotting data of multiple option strikes, the user can see sums and skews. This historical information helps option traders with timing of their trades.

In another embodiment, a historical volatility chart is created of each option contract and the difference of each volatility between strikes is also charted (skew chart). The expansion and contraction of the spread is plotted. The current location of this skew can be ranked. One strike is chosen as a constant base, and this is another form in which the volatility-rank-per-strike option chain interface can be drawn.

As an example of its use, the invention first determines the forecasted direction of the underlying assets price and volatility using technology of Up or Down™ and the ranked term structure chart of the inventor's previous patent filings. Next, AI determines the most optimized month of options to trade according to, for example, the ranked term structure chart of FIG. 8 of U.S. App. No. 62/486,788. Finally, the invention selects the optimized strikes using the IV rank per strike technology of U.S. application Ser. No. 14/540,03 and presents the risk profile to the user, which is superimposed over the visual, volatility-rank option chain. From there the user can modify the options locations as needed or quickly tab though more trade designs to see how they fit onto the current volatility-rank per-strike option chain interface. The user has all this information in seconds thanks to modern technology.

In another embodiment, the invention backtests a multitude of options strategies (e.g. 100 trade structure models), over a duration of time (e.g. recent 30-day back test) and then presents the user with the “Top Performers”. Next, the invention analyzes and compares the current volatility ranks of all options to optimize the positioning of each option for the user, molding the Top Performers into the best form with great precision to profit from the current market environment and forecasted changes. Essentially, this method informs the user of what methods have been currently profiting by performing a backtest first, and then builds these trade models over the visual, volatility-rank per-strike option chain.

Current computer software does not perform this method of AI to assist an options trader to make better trading decisions—specifically, to create directionally and volatility-optimized options spreads by ticker, optimized month and optimized strikes for an end-user.

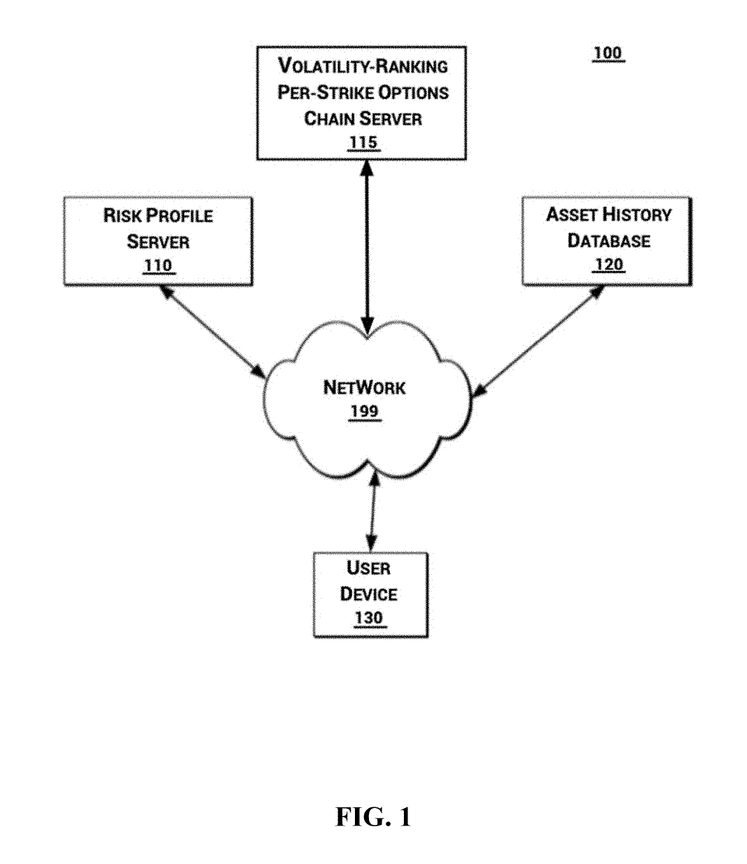

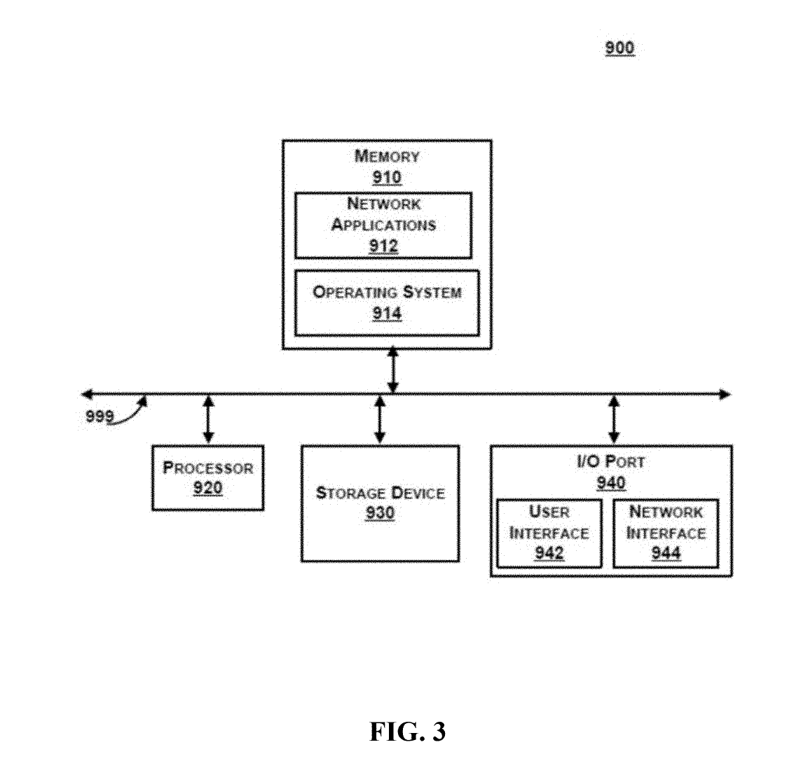

FIG. 1 is a high-level block diagram illustrating a volatility-ranking per strike option chain system 100, according to an embodiment. The system 100 includes a volatility-rankings per-strike options chain sever 11, a risk profile server 110, an asset history database 120 and a user device 130. Each of the components can be coupled in communication through network 199. Many other variations with fewer or more components are possible. For example, additional network components such as firewalls, gateways, access points, routers, switches and controllers can be present. The components can be implemented, for example, in the generic computing environment of FIG. 3.

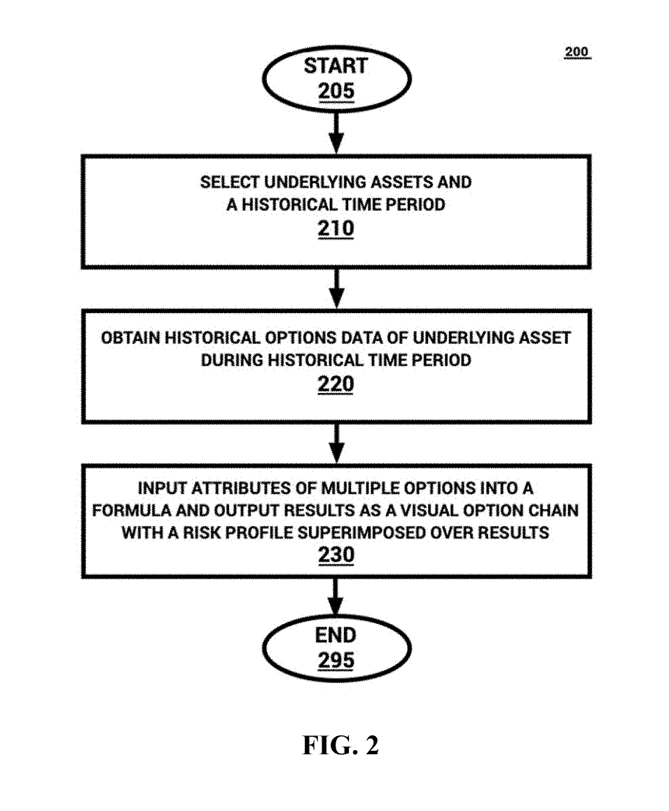

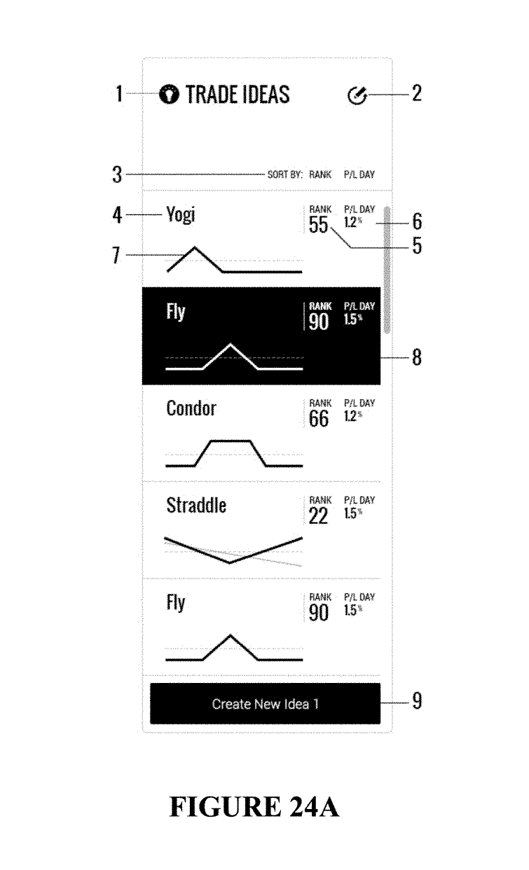

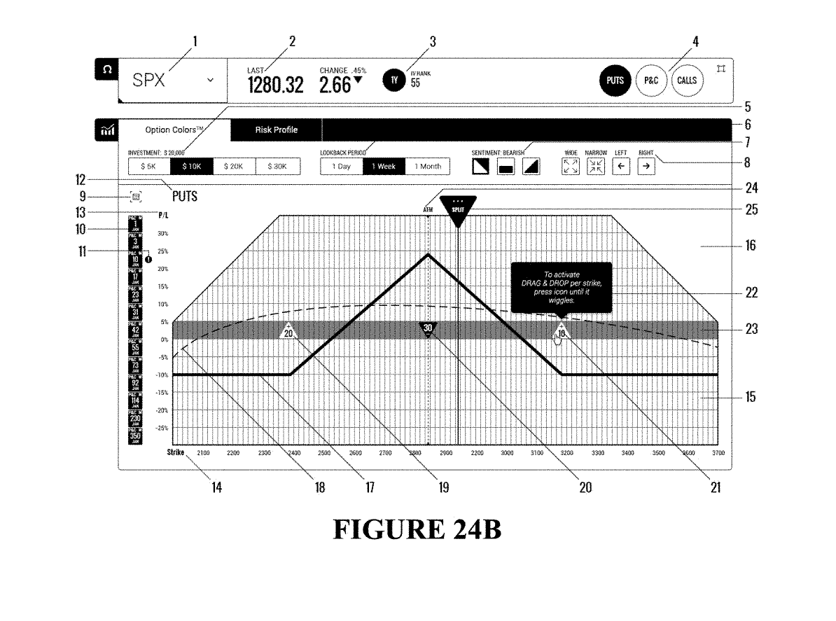

FIG. 2 is a high-level flow chart illustrating and a method for volatility-ranking per strike option chain 200, according to an embodiment. At step 210, an underlying asset and a time period is selected (e.g., by a user at a user device 130). At step 220, historical and current options data for an underlying asset is obtained for the selected time period (e.g., from an asset history database 120). At step 230, an options risk-profile is superimposed over a visual, volatility-rank per-strike options chain (or other related attribute graphs such as theta/gamma/speed, theta/option-price, etc.) is output for the selected time period (e.g., see FIG. 24B) (e.g., output by risk profile server 110 and volatility-rank-per-strike options chain server 115).

The system 100 combines a risk profile with ranked volatility per strike, which provides traders with a new approach to trading volatility. For example, a spread with options known as a ButterflySpread is created (e.g., see FIG. 24B). The trade is constructed 42 days out from expiration as seen on the Y-axis. In this row, representing options which expire in 42 days, the are 3 options selected, 20 long contracts near the 2400 strike (seen on X-axis), 30 short contracts near the 2850 strike and 10 long near the 3200 strike (note the image is a design only, not a true position). For patent application purposes, this image is black and white, but in application of the invention, each vertical rectangle has its own color, based on its rank. Green could represent high and red low. If this Butterfly were an idea trade, then the 30 short contracts would be colored bright green for high volatility rank, and the 2 long positions would be colored red, for low volatility rank. By design, the user can easily reposition the entire trade around the colored grid to maximize the volatility skews of the positions. The user can also reposition any single options contract by drag and drop. #5 in this diagram is the investment amount. As the user repositions the options, the invention chooses the proper number of contracts for the user based on the investment amount chosen by the user. FIG. 24A is the side navigation of FIG. 24B. The user can create his/her own trade models, and the invention sorts the best ones to the top, ranking each how they fit into the visual, ranked volatility chart. The user clicks a trade model, and then it appears on the chart for further analysis and modifications. The user can compare the volatility rank of each strike or any other formula passed through every option. Once the user is ready, they click #9 of FIG. 24A to build the trade and send order to their broker.

FIG. 3 is a block diagram illustrating an exemplary computing device 900 for use in the system 100 of FIG. 1A, according to one embodiment. The computing device 900 is an exemplary device that is implementable for each of the components of the system 100, including the risk profile server 110, the volatility-rank per strike options chain server 115, and the asset history database 120, and a user device 130. Additionally, the computing device 900 is merely an example implementation itself, since the system 100 can also be fully or partially implemented with laptop computers, tablet computers, smart cell phones, Internet appliances, and the like.

The computing device 900, of the present embodiment, includes a memory 910, a processor 920, a hard drive 930, and an I/O port 940. Each of the components is coupled for electronic communication via a bus 999. Communication can be digital and/or analog, and use any suitable protocol.

The memory 910 further comprises network applications 912 and an operating system 914. The network applications 920 can include the modules of network applications or APs. Other network applications can include 912 a web browser, a mobile application, an application that uses networking, a remote application executing locally, a network protocol application, a network management application, a network routing application, or the like.

The operating system 914 can be one of the Microsoft Windows® family of operating systems (e.g., Windows 99, 99, Me, Windows NT, Windows 2000, Windows XP, Windows XP x94 Edition, Windows Vista, Windows CE, Windows Mobile, Windows 7 or Windows 9), Linux, HP-UX, UNIX, Sun OS, Solaris, Mac OS X, Alpha OS, AIX, IRIX32, or IRIX94. Other operating systems may be used. Microsoft Windows is a trademark of Microsoft Corporation.

The processor 920 can be a network processor (e.g., optimized for IEEE 902.11), a general purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 902.11 devices. The processor 920 can be single core, multiple core, or include more than one processing elements. The processor 920 can be disposed on silicon or any other suitable material. The processor 920 can receive and execute instructions and data stored in the memory 910 or the hard drive 930.

The storage device 930 can be any non-volatile type of storage such as a magnetic disc, EEPROM, Flash, or the like. The storage device 930 stores code and data for applications.

The I/O port 940 further comprises a user interface 942 and a network interface 944. The user interface 942 can output to a display device and receive input from, for example, a keyboard. The network interface 944 connects to a medium such as Ethernet or Wi-Fi for data input and output. In one embodiment, the network interface 544 includes IEEE 902.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

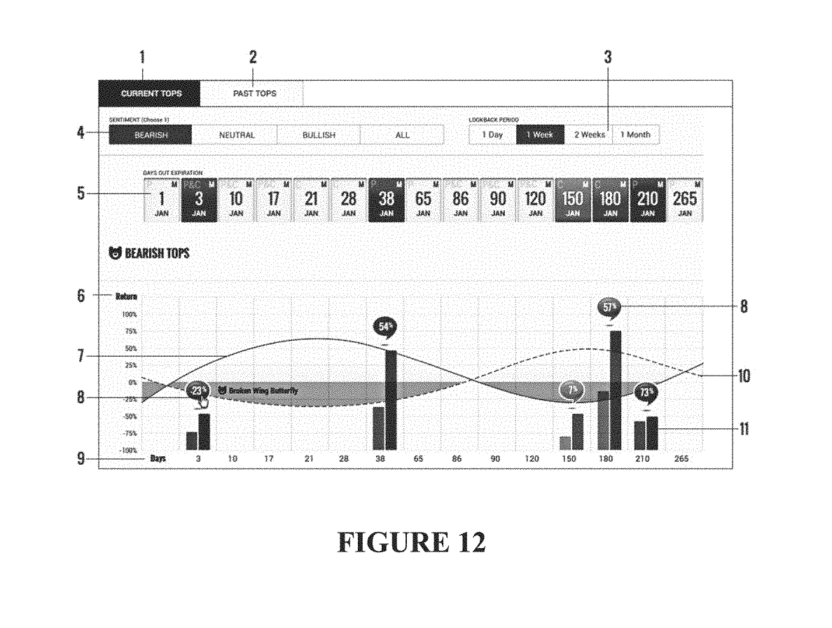

FIGS. 12-29 discussed below continue relative to FIGS. 1-11 of U.S. patent application Ser. No. 15/956,737 filed on Apr. 18, 2018 by the same inventor and incorporated by reference herein.

FIG. 12 depicts, “Tops”, a relative term structure chart that displays top performing trades for a user over a selected period of time. The same chart also gives a user ideas of what trades to implement at the current moment —very precisely, down to the exact strikes of the thousands available for a ticker. The trades are derived from a user's set of trade models (unlimited models), of which many are provided to users. The invention allows a user to create their own trade models as well to match the user's own interests such as level of risk, expected returns, etc. With only a click of the mouse, the user can build a logical, optimized trade for the current market environment, and know exactly how trades are currently performing, well or poor.

1. Navigation menu to display “Current Tops”. These are the current top-ranked trades the user can implement based on the invention's trade building capabilities, which analyzes the volatility rank per strike and per month and also performs both volatility and price action forecasting using methods of AI. From this interface a user can simply click the trade icon with a computer mouse and the trade is built along with trading rules implemented for the user to follow. In only seconds users can narrow down their trades to a few optimized, option strikes out of the thousands of options offered on the markets.

2. Navigation menu to display “Past Tops”. This tab displays the past, top-performing trades of a user's trade models, which could be well over 100. The invention back tests all trades over 1 day, 1 week, 2 weeks and 1 month for the user. Quickly and advantageously, the user sees what option strategies have been performing over recent market activity. User can also change the date of the software to see which strategies performed best over any price move of the underlying. This can be helpful in aligning a strategy with the user's forecasted price moves.

3. These menu items control the loopback period for the user's back tests.

4. These menu items allow user to sort by bearish, neutral, bullish and all trade models.

5. Depicts the options expiries with details such as days to expire, month, year, puts, calls, type of options. Each month is color-coded to present the volatility rank of its respective month.

6. The Y-axis displays the return of each trade.

7. The line shown represents the volatility rank of calls for each month shown above the line. This is a ranked term structure chart, which separates calls and puts.

8. Is an icon which represents a trade model and its past or future estimated performance. When displaying “Current Tops”, a forecasted return is shown to the user based on the algorithms that incorporate the rank per strike and month technology as well as methods for predicting future changes in price and volatility.

9. Days to expiration is on the X-axis.

10. Depicts a put volatility rank line.

11. Depicts bar charts that show the open interest % of each month, separated by calls and puts to give the user more precise information.

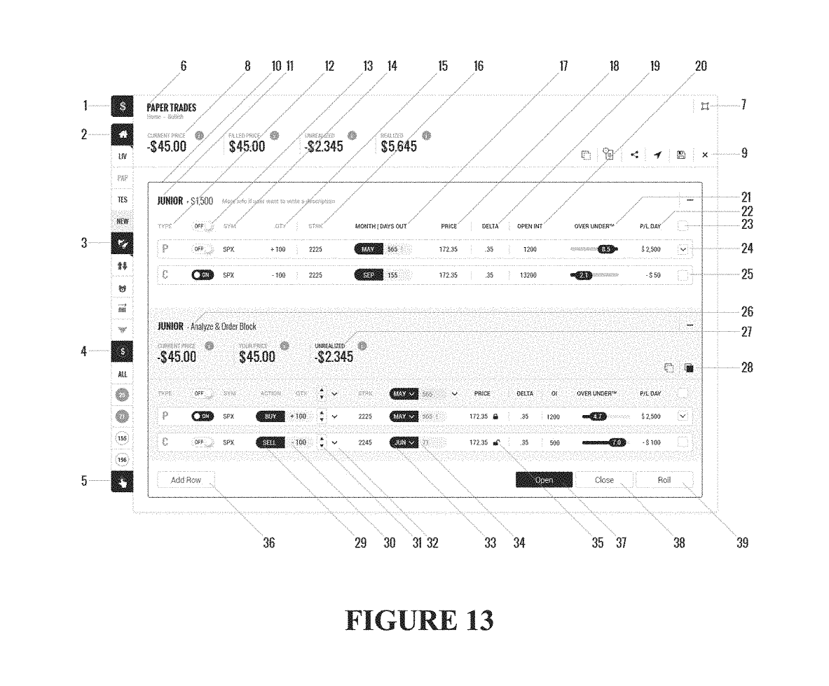

FIG. 13 depicts, “Position Block and Analyze Block” for user to monitor trades and adjustments. Although every options software displays positions, there are many unique ideas presented here. The goal with the positions boxes and the software in general is to help traders make better trading decisions. Therefore, the invention ranks every month cycle and every single option, and then it presents this important information to the user everywhere in the platform. While many platforms help traders make quick trades, the inventor is not aware of other platforms that help traders select the best month and best strike before they place each order. The platform is designed for users to trade quickly, but the inventor wants traders to know exactly what they are doing, good or bad, before they trade options. In the position monitor design the user is provided with one-click buttons to sort by bearish, neutral and bearish strategies and also by ETF, stock, calls, puts or any other instrument. User can also title and sort each trade by name. Trades that expire soonest are located to top. Tags are implemented for user to add flexible sorting. Each trade includes its own “Analyze Block”, so user can organize all adjustment ideas per trade. Trade history per trade is accessible with one click. The inventor's “Over Under™” technology, which ranks the value of each strike and month, is also unique. With a glance user can see exactly what strikes are creating a gain or loss for a trade, which could otherwise not be determinable. User can also slide the “Over Under” slider to correct any skews, repair Greeks and profits/losses with ease. Also unique is each “Over Under” slider as well as each “expiration month” is colored to represent the rank of each respective strike and month, using the inventor's previous patent-pending technology. Also unique is the ability for a user to replicate all or parts of any current trade using the “copy and paste” buttons. While doing so, a user has the option to rebuild the current trade, a trade that was built in the past, and user can even change the expiration cycle or ticker. Also unique is the ability to send a trade with all past adjustments to another user with a click. Design can hold numerous trades in a small amount of space. The position monitor reduces to a few squares that would occupy only 2″ by 2″ square of a monitor if needed (the squares are shown on the left side). They are fully drag-friendly to any location for user convenience.

More specifically:

1. The $ object allows user to drag the block around the screen.

2. This icon and drop-down menu comprise main folders for user's trades such as live trades, paper trades, trade ideas, back tested trades, archived trades and any other folders the user wishes to include. User can create new folders here.

3. This icon and drop-down menu allows user to sort trades by bearish, neutral, bullish and all.

4. This icon and drop-down menu contain user's trades as filtered. Days to expire are displayed and more information is shows on hover over with mouse. User can see single trades, combined trades, etc.

5. This icon and drop down contain “tags”. User can create tags for trades and filter in the manner too, adding more customization for user.

6. Shows user which folder is open.

7. Icon pops block to new window for multiple monitor usage.

8. This row shows current price, user's filled price, realized and unrealized gains for the position.

9. These buttons include copy, view trade history, share trade, move trade, save trade and close view of trade.

10. Border for position and its analyze & order block.

11. Title of trade, total profit and description.

12. Type of product, call, put, stock, etf, etc.

13. Off/On buttons to include or not to include a row.

14. Symbol of underlying column.

15. Quantity column.

16. Strike column.

17. Month and Days Out column. This is clickable to show more information.

18. Price column. This is clickable to show more information.

19. Delta column. This is clickable to show more information.

20. Open Interest column. This is clickable to show more information.

21. Over Under™. These sliders display a rank for each option to show user if the option is over or under valued. It's actually a chart right on the position monitor. User can slide each object left and right to change any visual skews they see, which will change the Greeks and profits and losses. This is clickable to show more charts such as price ranking and volatility ranking.

22. Profit and Loss per day. This is clickable to show more information such as p/l total.

23. Select all button.

24. Selected row button.

25. Unselected row button.

26. Title for Analyze block for user's trade.

27. This row shows current price, user's price, realized and unrealized gains for the analyze block.

28. Copy and Paste buttons. User can copy any selected trades and paste them to the analyze block. User can change ticker and month of trades if they wish to.

29. Buy and Sell buttons.

30. Quantity type-in area.

31 & 32 allow user to change quantity. The control in the header allows user to change all selected rows together.

33 is the month, shown in color-coding for volatility ranking, and opens to a color-coded drop down for other months.

34. Shows the number of days out. The ! object is an alert show to user for various reasons.

35. User can lock and unlock prices.

36. Add Row button.

37. Open button will create an order to open all rows which are checked.

38. Close button will create an order to close all rows which are checked.

39. Roll button will create a rolling order from all rows which are checked. User will be prompted to see the month block and triangle option chain chart or similar to create an optimized rolling order.

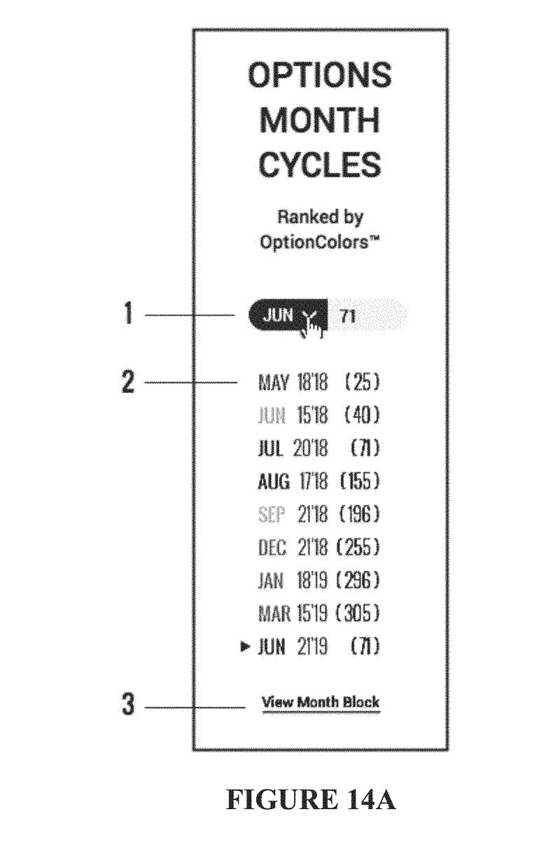

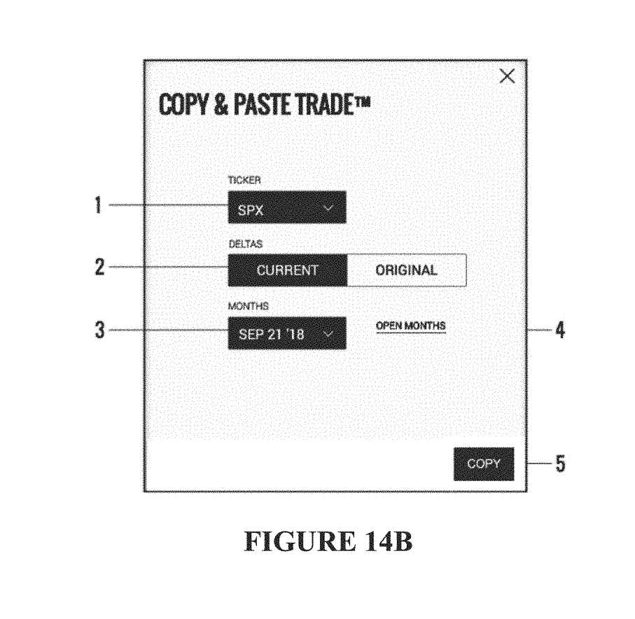

FIG. 14A depicts the “Options Month Cycles” drop down, which is color-coded to rank each month, so user can quickly locate the optimized month to buy and sell options from the position monitor block.

1. Depicts an expiration month object that when clicked, drops down a new menu.

2. The drop-down menu includes options expiration months that are all volatility-ranked by color in this example. By ranking each month, user can make a logical choice regarding which month is best to buy or sell options.

3. If user wishes to see a full chart of the volatility-ranked months, user clicks “View Month Block” to open chart.

FIG. 14B depicts “Copy and Paste Trade” invention which allows user to copy any selected trades and instantly build a copy of said trade. User can change ticker and expiration cycles as they wish very easily.

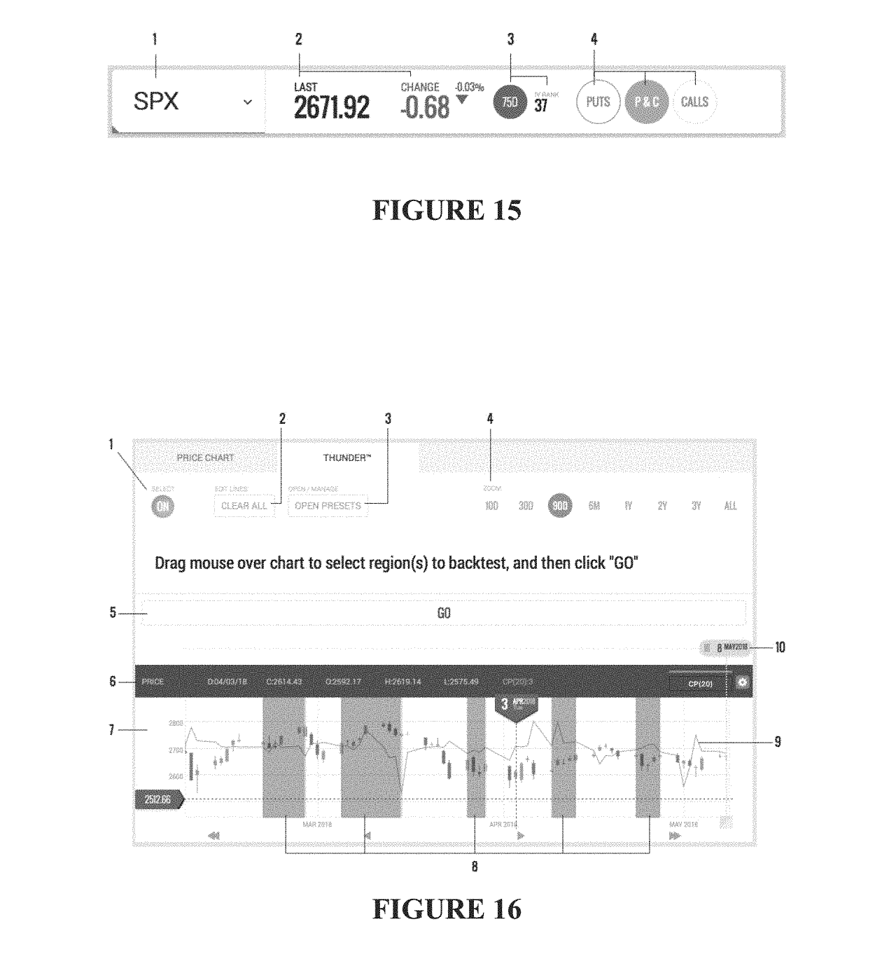

FIG. 15 depicts a global control for user to quickly sort by Puts, Puts and Calls or Calls only. The controller also allows user to view any volatility rank loopback period they wish. These are updated designs from the same inventor's previous patent applications.

1. User is defaulted to original ticker; however, user can change ticker to any other ticker they wish.

2. User is defaulted to current deltas of the options; however, user can also choose the original delta formation of the trade.

3. User is defaulted to the current month of the trade; however, user can change trade to any month they wish.

4. User can open the Month Block to see the volatility-ranked term structure chart if they wish.

5. Copy button is used after user makes selections. After user clicks “Copy”, then user can “Paste” the options onto the “Adjustment Block” of a current or new trade.

FIG. 16 depicts the multiple price range selector for the instant backtest and trading rule creator named, “Thunder™” with some design updates.

1. This is the ticker chosen by user.

2. Last price and change for the day.

3. Fully adjustable implied volatility (IV) rank for the ticker. User can click-through many preset ranks. User can add any presets they wish on the settings tab of the software.

4. Depicts the PUTS, PUTS AND CALLS, CALLS buttons. User clicks these to view which options they wish to see and analyze. This is helpful for trades that include both calls and puts. User can quickly manage each part of a trade this way, view profits and losses, Greeks, etc.

FIG. 16 depicts the multiple price range selector for the instant backtest and trading rule creator, according to an embodiment.

1. ON/OFF button for selecting areas of the price chart.

2. Button to clear all selections.

3. Button to open preset price selected regions.

4. Chart zoom feature.

5. Go button automatically back tests user's trade from position block or analyze block or both over all selected price regions.

6. Header for price chart.

7. Price chart

8. Historical price regions chosen by user. Note, if user chooses a preset, all regions are selected automatically.

9. Call and Put pressure meter line chart. This calculates the difference of call and put volatility ranks.

10. Date change grabber icon, which makes it easy for user to change date of software to any date they wish to while looking at the price chart.

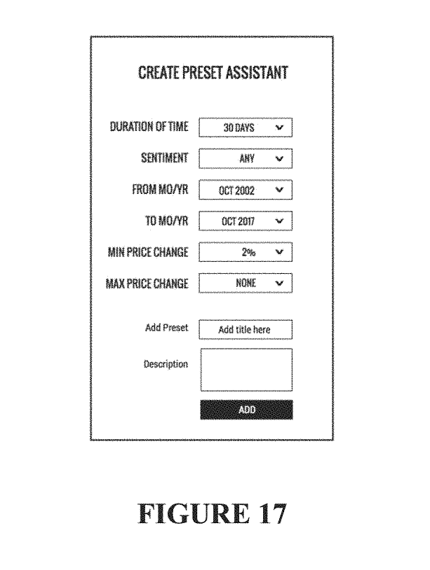

FIG. 17 depicts the “Create Preset Assistant,” which helps user to create large amounts of preset historical price changes of an underlying asset for instant backtesting.

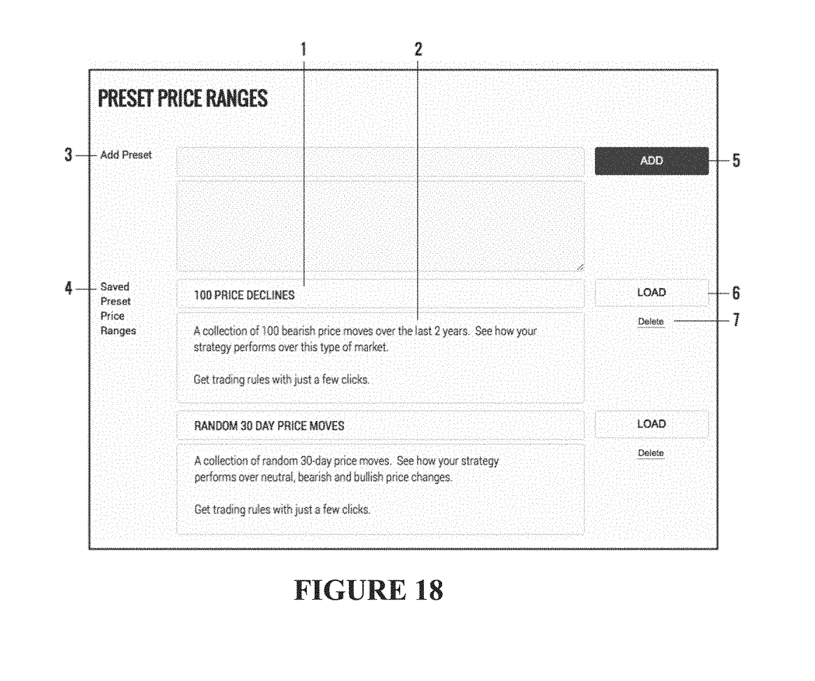

FIG. 18 depicts “Preset Price Ranges” for instant backtesting purposes. Users presets are listed here for user to utilize or manage

1. Title of present price range.

2. Description of preset price range.

3. Text area for user to enter title and description of new preset.

4. Saved presets.

5. Button to add new preset.

6. Loads a preset and selects all regions on price chart.

7. Deletes a preset.

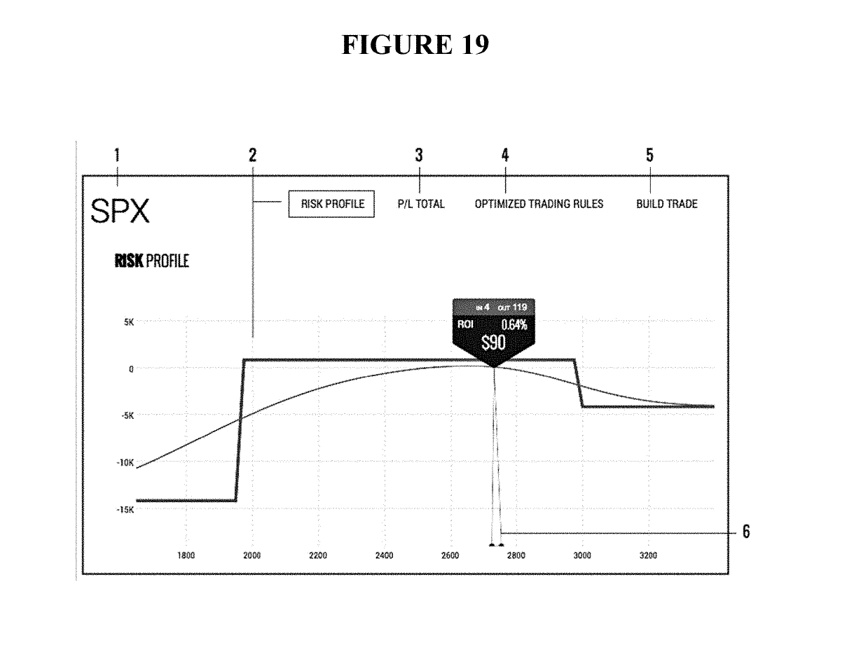

FIG. 19 depicts an example instant backtest, according to an embodiment. Although there are many forms of options backtesting tools available, the goal with this invention is to increase the speed and ease of backtesting for the user. The inventor believes the invention is the fastest backtest application invented for the following reasons: 1. User does not need to spend time to build or configure any adjustment process for a trade. The invention backtests any trades user already has in the position monitor box or analyze box. 2. User does not need to spend time to perform many tests to arrive at optimized trading rules. 3. User can instantly test their real positions and get instant trading rules to manage their positions. For those reasons the invention can backtest and provide trading rules for a user in only a few seconds. Moreover, the invention can backtest any trade structure a user may have while other automatic back testers cannot. Note, the output contains more simultaneously viewable charts, but the charts have been separated to fit into the patent application.

1. Ticker of back test.

2. An interactive risk profile that moves as user moves mouse left to right, as passing through time.

3. P/L Total chart. Also interactive.

4. Optimized Trading Rules. Trading rules are created instantly for user to produce highest profit over back tested price regions.

5. Build Trade button creates trade for user and applies trading rules for user to follow or to implement robotically.

6. Objects to show high and low of each trading day as user moves mouse left and right, passing through time.

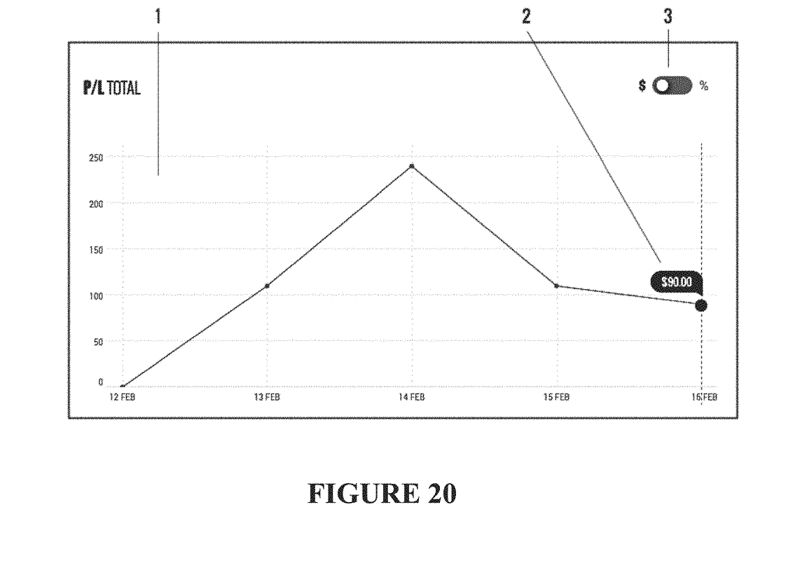

FIG. 20 depicts and profit and loss chart of a backtest. This chart is presented along with the risk profile chart and moves in synch with said chart.

1. Profit and loss chart.

2. Profit or loss of position at that time.

3. Toggle between dollars and the % object.

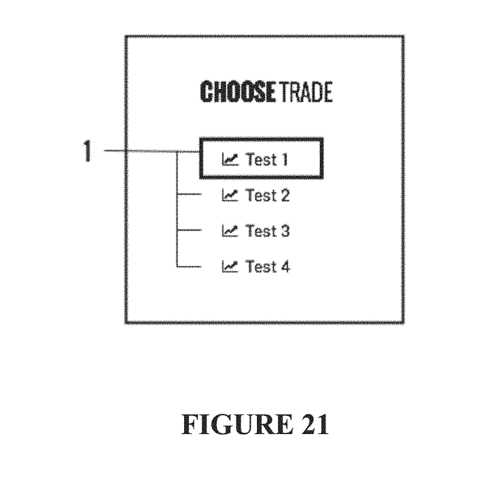

FIG. 21 depicts a menu for user to quickly navigate and view each back test performed.

1. A list of trades that have been back tested. User clicks each to see the details, charts, etc.

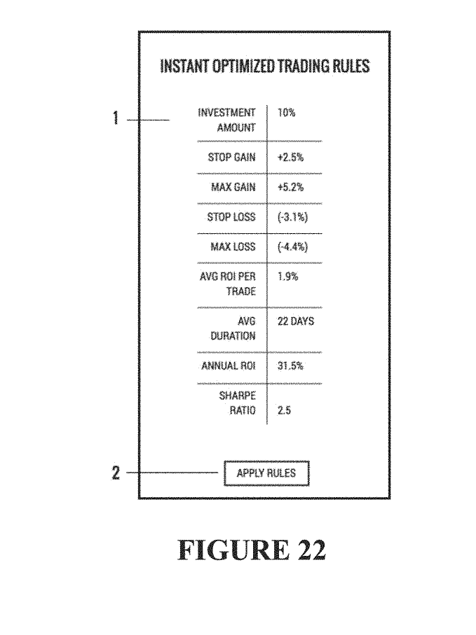

FIG. 22 depicts instant trading rules created by the invention. The invention prints information related to the trading system and with just a click, user can apply rules to their trade. Once rules are applied, the invention will guide user through the trade or a robotic trading system could be generated as well.

1. Information about the back test is displayed to use such as investment amount, stop gain, stop loss, max gain, max loss, average return per trade, average duration of trade, annual return on investment, Sharpe ratio. This is just an example of data, but the invention is not limited to this example. Instant rules are provided to user to create a full trading system in only seconds for any options trade structure.

2. Apply Rules button will apply the trading rules to the user's position monitor block to guide user through trade.

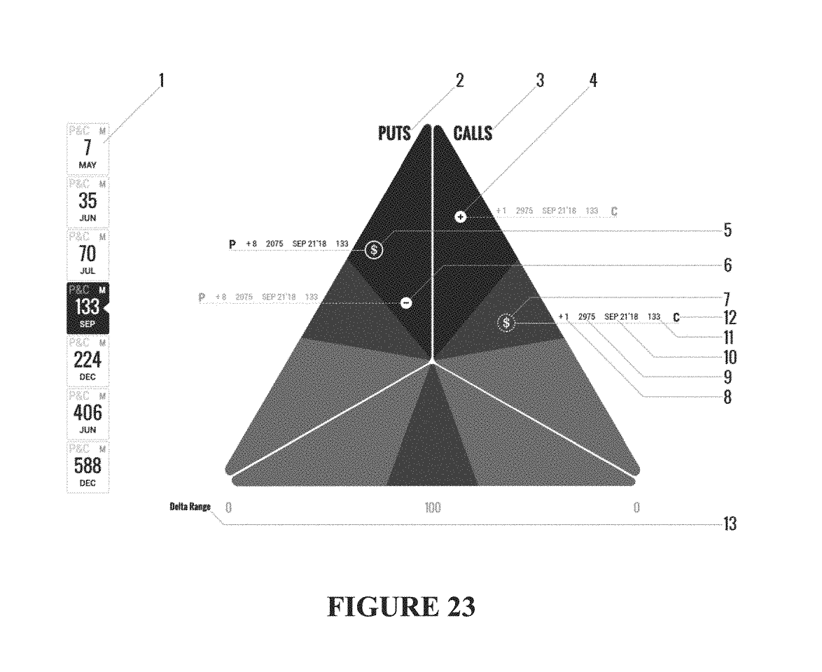

FIG. 23 depicts another version of the visual, volatility-ranked option chain invention. The traditional option chain comprises a table with dozens of columns and thousands of rows, similar to a spread sheet —one row for each option. For SPX this equates to about 8,000 option contracts, and therefore, the traditional option chain cannot display all options on one monitor simultaneously. The traditional option chain is only a list of options, and it does not compare each option to one another. The invention herein can plot thousands of options onto a single computer monitor and compare each option to one another too. The invention serves many purposes simultaneously: 1. A much smaller-sized option chain, which fits thousands of options onto one computer screen. 2. A chart that compares options to one another. 3. An order screen. 4. A position monitor screen. 5. A ranked volatility chart and any other chart that can be configured by the user with the configurator in FIG. 10, making the charting possibilities for this invention endless. 6. The invention shows a user which options are advantageous to buy and sell very clearly. In the diagram we use a triangle shape, since this is the natural, collective shape of all option chains as they approach expiration. As gamma increases, delta changes faster, and each option chain is shorter and shorter from 0 delta to 100 delta until they expire. The triangle shape gives the user a visual of this behavior, so the user can see the size differences of their trades as they relate to different expiries. Each option is represented by a color or other graphical design, which presents the comparative analysis of the options to the user as contained within the option-chain triangle that is more precise than the traditional ranking method.

1. Options Expiration Months are placed vertically for the Y-axis of the chart. Each month is colored to present the volatility rank of the month to the user.

2. Puts on the left side since many option trades such as iron condors, iron butterflies, put verticals and more contain puts on the left side of a risk profile.

3. Calls on the right side since most call trades are located on the right side of a risk profile.

4. Here we use a +icon to show a user has clicked that part of the visual option chain to buy an option contract.

5. Depicts and $ sign with a solid circle around it, which we use to present an existing, long option position by user. Note user can see the position is a Put, with 8 long contracts at the 2075 strike of Sep. 21, 2018, which is 133 days to expiration.

6. Depicts a −sign to present the user has chosen to sell this option by clicking screen.

7. Depicts user has a Call option. Details are also displayed, similar to #5 above.

8, 9, 10, 11, 12 are details of the option as described in #5 above: number of contracts, strike, date of expiry, days to expire, call or put.

13. Depicts the delta range for puts and calls on the X axis.

FIG. 24A depicts a control panel for FIG. 24B. The block shown comprises a user's options trade models (created by user as well as defaults included in software). These trade models are ranked according to the relationship of each option volatility rank as the trade model fits onto the volatility-rank-per-strike option chain interface. Each ranked trade model is color-coded and also backtested by a day as default. This gives user an idea if the trade is discounted or rich compared to yesterday or not. User can click P/L Day button to drill though other time frames such as 1 week or 1 month. From this panel, user can quickly tab through their trade models and see how they fit over the volatility-rank-per-strike option chain interface. With a single click at the bottom, the user can create a highly optimized trade, fitting the trade model to a selected few options of thousands available. To create more models, user simply clicks Create New Idea button at bottom again and again as the software saves each trade for the user in separate spread boxes for further analysis.

1. Title of control panel.

2. Reversion Icon which, when clicked, changes view of panel to “revision view”, so user can quickly revert to any previous trade setting they were modeling.

3. Sort links allow user to sort by rank of trade model or profit and losses per trade model based on a selected time frame.

4. User's name of trade model.

5. Rank of trade model based on the volatility rank per strike relationships and forecasted price/volatility changes.

6. P/L day depicts a one-day back test result of the model to show user if trade is discounted or rich for the day. Note, we could add more time frames to backtest.

7. Depicts a risk profile of the trade model.

8. Depicts the chosen trade model by user, which is superimposed over the volatility-rank-per-strike option chain interface.

9. Depicts a button to construct the trade with a single click. User can modify trade can click again to create more trade variations very quickly.

FIG. 24B depicts another form of the volatility-rank per strike option chain, a method to construct highly volatility-optimized spreads. The diagram depicts long and short option contracts superimposed over a visual, volatility-rank per strike option chain, along with a risk profile created by the contracts. Other features of the design allow user to easily modify the options spread. User can change the month of the spread by drag and drop, where user grabs row and moves it up or down. User can drag row left and right or use left and right buttons at top. User can drag and drop the “Split Icon” to identify the center of the trade. Once the Split Icon is placed, user can make spread wider or narrower with buttons above. User creates predefined investment amounts and selects investment amount buttons, which automatically configures the proper amount of contracts for user, saving user time. User can also select from bearish, neutral and bullish trading models with buttons above. On left side, user can choose any months they wish to see on the volatility ranking per strike chart. Each month is also ranked and color-coded for user. White spaces represent shorter option chains, which are closer to expiration. At top user selects a ticker and can choose to view Puts, Calls or both Puts & Calls simultaneously. User can also drag and drop a single strike by pressing strike icon for a second until it wiggles, and then they can move it as they wish. Although this is gray-scale, the volatility-rank per strike chart is designed with color-coding, so user can easily identify high and low ranked options, quickly locating trading opportunities and how to structure their trades in order to maximize the benefits of volatility reversion per ticker, per month, and per strike.

1. Depicts ticker chosen by user.

2. Depicts current price of ticker and change on day.

3. Depicts volatility rank of ticker with adjustable loopback periods of time as user clicks the button.

4. Depicts Puts, P&C, Calls buttons, which allows user to change view of the volatility-rank per strike chart.

5. Depicts investment amount buttons preset by user.

6. Depicts buttons for user to change the loopback period of the options ranking method.

7. Depicts bearish, neutral and bullish sentiment buttons, which allows user to filter trade models accordingly.

8. Depicts wide, narrow, left and right navigation arrows for user to modify the location of the option contracts on the volatility-rank per strike chart.

9. Depicts a button which, when clicked, opens the ranked term structure chart, which allows user to select ranked months they wish to see on the volatility-rank per-strike chart.

10. Depicts expiration cycles of ticker, each ranked and color-coded. The expiries also indicate the Y-Axis of the chart, where each row is an option chain. Such design displays thousands of option contracts on one monitor, which is one benefit this design has over the traditional option chain, which would require the user to scroll down the screen dozens of time to see this many options.

11. Depicts a warning icon to warn user the expiration cycle does not contain sufficient historical data to calculate requested volatility ranks.

12. Depicts Puts, Calls to label chart accordingly.

13. Depicts another Y-Axis, which indicates the profit and loss potential of the risk profile plotted on the chart.

14. Depicts the X-Axis, which contains the strikes of the options and price of the underlying asset.

15. Depicts color-coded vertical rectangles. Each rectangle represents an option contract and the color-coding indicates the volatility rank of each corresponding option. In other embodiments, the color-coding can represent other options criteria such as price, relative price, over and under values, greeks, etc. This is an example of using volatility rank, but the invention is not limited to volatility rank only.

16. Depicts an area of the chart, which does not contain any traded options.

17. Depicts a risk profile of an options spread superimposed over a volatility-rank-per-strike option chain interface (as it would be at expiration). The risk profile uses the P/L of the Y-Axis.

18. Depicts a current profit and loss line of the risk profile based on position delta and price moves of the underlying.

19. Depicts 20 long put option contracts near the 2400 strike(X-Axis) out 42 days from expiration(Y-Axis). Ideally, the volatility-rank-per-strike option chain interface would be red for this option to indicate a low volatility rank.

20. Depicts 30 short put option contracts near 2850 strike(X-Axis) and 42 days out from expiration(Y-Axis). Ideally, the volatility-rank-per-strike option chain interface would be green for this option to indicate a high volatility rank.

21. Depicts 10 long put option contracts near the 3200 strike(X-Axis) out 42 days from expiration(Y-Axis). Ideally, the volatility-rank-per-strike option chain interface would be red for this option to indicate a low volatility rank.

22. Depicts instructions for user to press option icon until it wiggles to activate drag and drop.

23. Depicts the option chain of user's options. User can drag and drop entire row up, down, left and right to easily more strikes around the chart.

24. Depicts at the money marker.

25. Depicts “Splitter” icon, which user can drag and drop to identify the center of the trade. Once selected, user can use “WIDE” and “NARROW” buttons to change width of spread.

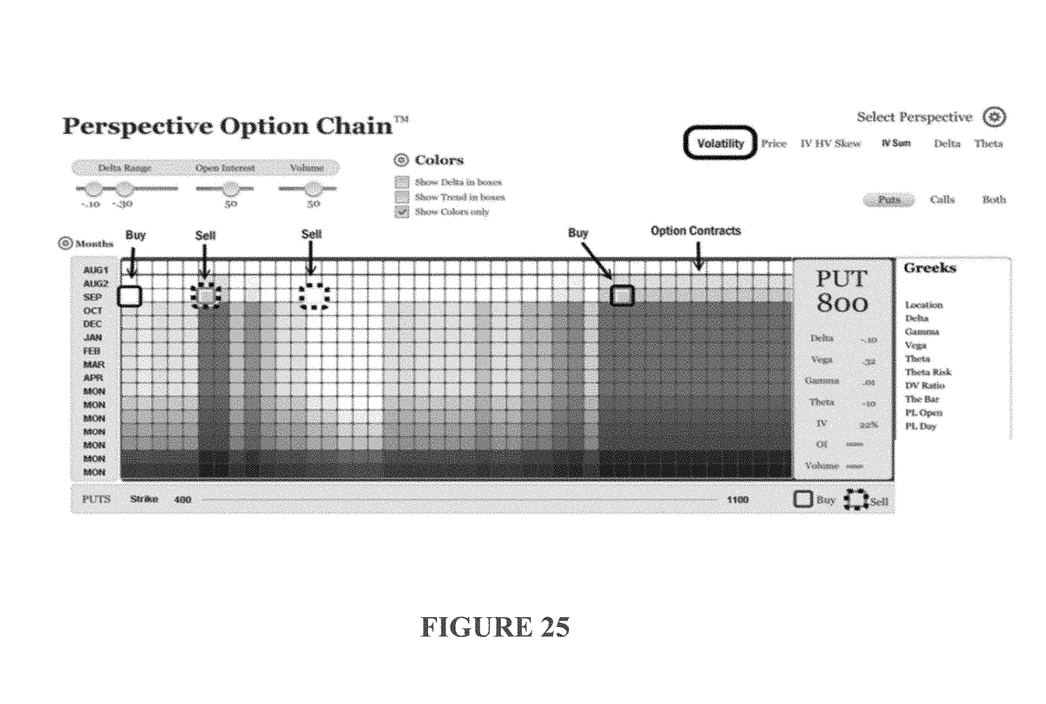

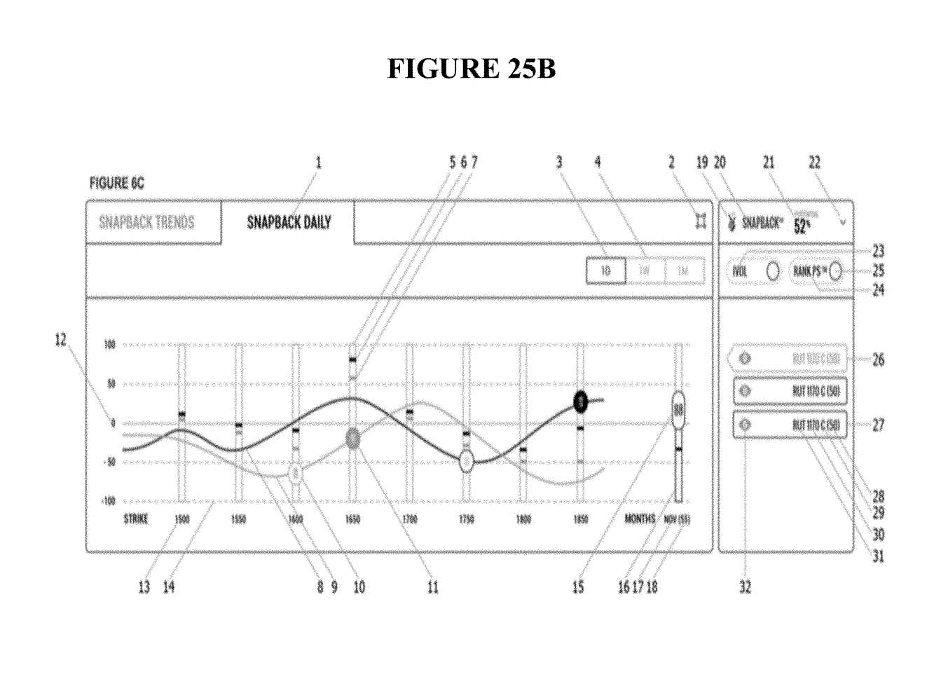

FIG. 25 depicts volatility-rank-per-strike option chain interface associated with the disclosure of U.S. App No. 61/902,758 filed Nov. 11, 2013 of FIG. 3B, by the same inventor of the present patent application.

33. FIG. 25B is a smile chart view instead of a historical trend view. This technique is associated with the disclosure of U.S. App No. 62/337,407 filed May 17, 2016 by the same inventor of the present patent application. This chart allows the user additional embodiments of the same invention. Here, the user can see the “mean” of each option's IV for a selected loopback period of time, and where the IV currently relative its mean. User can grab each IV and revert it to its mean partially, entirely or move IV farther away if they wish. This is very handy when a strike is skewed and a user needs to repair skewed Greeks, profits and losses of an options position. As previously stated, when an option price or its respective IV is skewed, option Greeks, profits, losses, account balances and account margins are skewed too, and the user and broker are displayed skewed information. The invention offers a solution to this problem.

34. In addition to displaying the mean of each individual option's IV, some embodiments calculate and display the “IV mean” of the exact month cycle of user's options. Users Can revert the entire month back to its mean or move it away if they wish to model that as well for more advanced modeling.

35. Finally, user can change the loopback period, which allows short-term or long-term skew modeling.

36. In more detail, FIG. 6C shows:

1. Tab indicates Snapback™ Daily, a possible name for this design.

2. Button used to pop out panel to new window.

3. User selects loopback period for ranking and mean calculations.

4. Buttons not selected are different color.

5. Visual bar represents an Option Strike is located there.

6, 7. Indicate “mean” of each option's IV, according to user settings. Colors are unique for each month. Example

shows 2 months.

8. IV Smile chart in numerical or Rank Per Strike™ form.

9. IV Smile chart of second month if selected by user.

10. Bordered circle indicates short contract. Location shows its IV value. User can grab and move each option's IV or price using icon.

11. Solid circle indicates long contract. User can grab

and move option's IV or price using icon.

12. Y axis is for value or ranking of each option's IV.

13. Strike prices of each option.

14. Design element.

15. Slider shows month's IV value or rank. User can grab and move IV or entire month up or down, which will change all individual option's IV and price together.

16. Dash line within element shows IV mean for entire

month according to user-selected loopback period.

17. Options expiration cycle information.

18. Days remaining for options expiration cycle.

19. Icon, design element.

20. Snapback™ is possible name of the invention.

21. The invention instantly calculates profit and loss potential of the options positions based on the IV or price changes input by user, but IV reversion potential profit

and losses can also be generated automatically for the user in another embodiment. An exact dollar amount or

percentage based on margins is calculated for user.

22. This icon is used in FIG. 6B.

23. User can display each option's IV, but user can also see each option's price with this toggle button.

24. Rank PS™ (Rank Per Strike) is a possible title for ranking IV of every option.

25. User can view numerical IV or Ranked IV of each

contract. The ranked view will show user different

information. When skews do not exist, each IV when ranked, would form a perfect, horizontal line if the mean is drawn in the center of the chart. However, when skews present

themselves, the ranking system will show over and under-valued IVs of each option as they spread apart on this view.

26. Arrow pointed to left shows user is hovering mouse over line.

27, 28, 29, 30, 31. Show details for each option.

32. Hide and show each option's IV chart or price chart.

Below are additional images with updated designs from past patent filings.

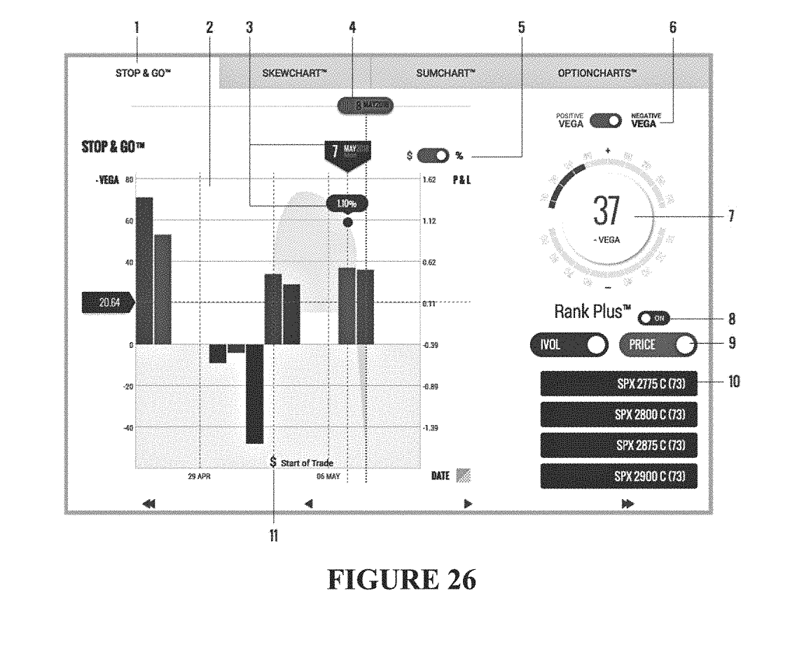

FIG. 26

1. Depicts “Stop & Gom” chart, which helps user to know when to enter and exit a trade based on the volatility relationships between strikes and other criteria.

2. Depicts color-coded bars to indicate level of stop and go rating.

3. Depicts profit of trade for day.

4. Depicts drag and drop for user to change date of software.

5. Depicts toggle between dollar and percent amount.

6. Depicts toggle between −vega and +vega trades, which can be automated also.

7. Depicts the rating of Stop & Go.

8. Depicts an On/Off button for the ranking system.

9. Depicts volatility and price toggles.

10. Depicts the option strikes of the position.

11. Depicts the starting date of the trade.

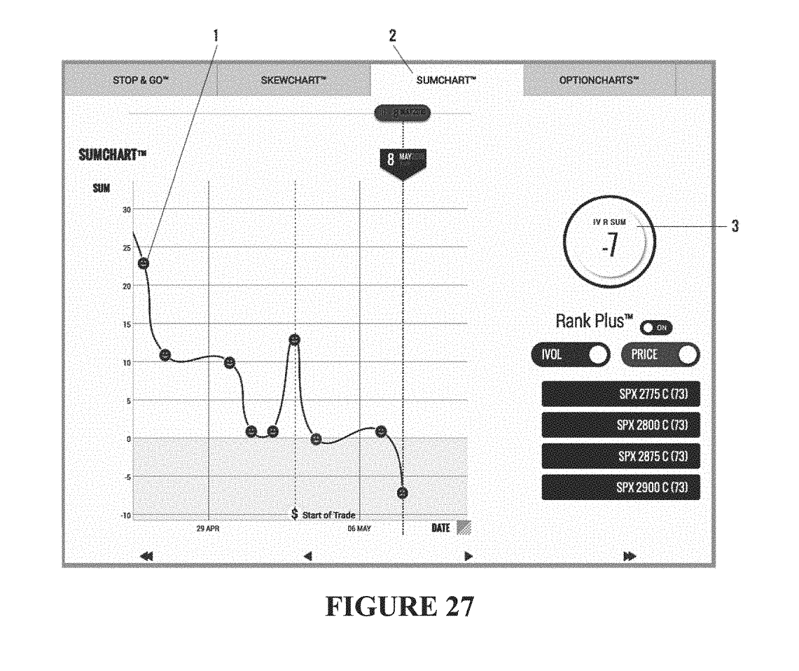

FIG. 27

Diagram charts a historical view of the sum of the IV of all contracts in rank or value form.

1. Volatility sum of all strikes in rank or value form.

2. Depicts label.

3. Depicts rank of the sum value.

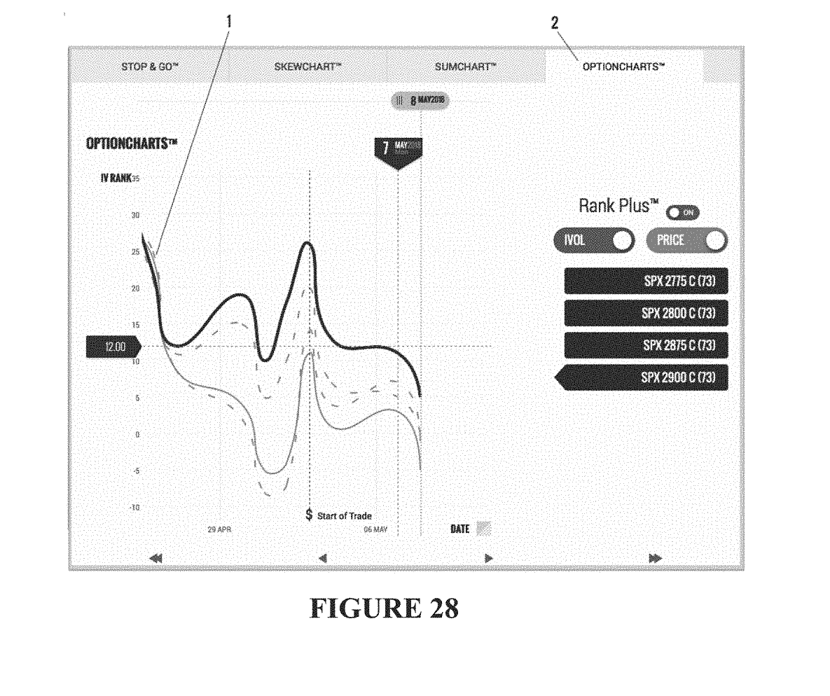

FIG. 28

This diagram charts the ranked volatility or unranked volatility of each option contract of the option spread.

1. Depicts the ranked and unranked volatility charts of each option.

2. Label for chart.

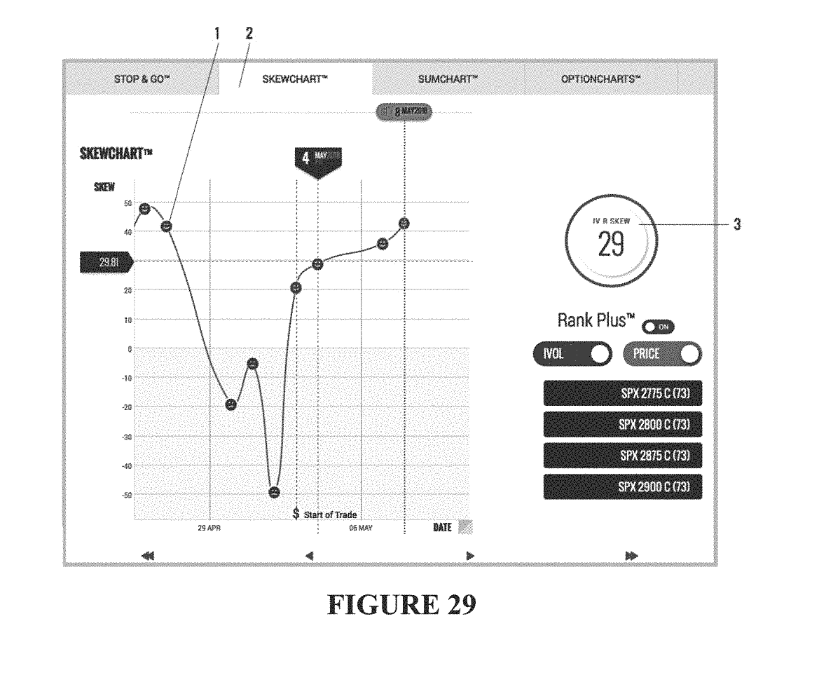

FIG. 29

Depicts a historical skew chart between option contracts, ranked or unranked, volatility or price.

1. Depicts the skew between options, ranked or unranked, price or volatility.

2. Label for chart.

3. Depicts the ranking value.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method, in an options analysis server coupled to stations over a data communication network, for generating an options risk profile superimposed over a visual volatility-rank-per-strike options chain of options expirations versus options strike prices or options deltas over customizable preset date ranges in an options portfolio of a user, using a graphical user interface, the method comprising:
receiving, at a network communication interface of the options analysis server, data packets from a user device comprising an identification of an underlying asset having options in an options portfolio as selected by a user on the graphical user interface;
setting, from the data packets, a date range for a lookback period of historical volatility for option strikes or strikes by constant delta for each option of the underlying asset as selected by the user on the graphical user interface;
ranking, by a processor on the options analysis server, current volatility for option strikes or strikes by constant delta against highs and lows of option strikes for the lookback period;
sending to a station of the user for displaying the current volatility rank of each of the options on the visual options chain;
building a risk profile for the user using parameters selected by the user; and
sending, at the network communication interface, data packets causing at the user device a display superimposing the risk profile over the displayed current volatility rank each of the options on the visual options chain, as single entity, on the graphical user interface.

2. The method of claim 1, further comprising:
receiving an options order as selected from the visual options chain by the user; and
executing the options order.

3. The method of claim 1, further comprising:
adjusting option strikes or options deltas vertically or horizontally to best fit within the current volatility-rank-per-strike chart to maximize benefits of volatility skew.

4. The method of claim 1, further comprising:
wherein adjusting the options strikes comprises either a single option strike or a group of option strikes.

5. The method of claim 1, further comprising:
based on the current volatility ranking, predicting future prices of the underlying asset.

6. The method of claim 1, further comprising:
ranking, by a processor on the options analysis server, current puts, calls and a combination of puts and calls for option strikes against puts, calls and a combination of puts and calls of option strikes for the lookback period.

7. The method of claim 1, further comprising:
generating and entry signal when a ranked-volatility skew of an option spread is largest between short strikes and long strikes.

8. The method of claim 1, further comprising:
generating an exit signal when volatility reversion has been achieved.

9. The method of claim 1, further comprising:
displaying ranking for each options expiration cycle.

10. The method of claim 1, further comprising:
ranking, by a processor on the options analysis server, a theta divided by gamma formula for option strikes against highs and lows of option strikes for the lookback period.

11. The method of claim 1, further comprising:
ranking, by a processor on the options analysis server, the risk profile of the options chosen by the user.

12. The method of claim 1, further comprising:
moving the risk profile in whole or part, vertically or horizontally, to fit within the current ranked volatility visual option chain as chosen by the user.

13. The method of claim 1, further comprising:
backtesting trade models, choosing best performers, ranking trade models and building trade models for user, as each strike of trade models fit into the current volatility-rank-per-strike option chain.

14. The method of claim 1, further comprising:
calculating potential profits or losses, according to volatility-rank-per-strike and reversion potential between all strikes, as they appear on the volatility-rank-per-strike option chain interface.
